(19) United States
(12) Patent Application Publication
(10) Pub. No.: US 2021/0401057 A1
(43) Pub. Date: Dec. 30, 2021

(54) DISPOSABLE ELECTRONIC CIGARETTE WITH A LARGE NUMBER OF PUFFS AND ITS CONTROL METHOD

(71) Applicant: HUIZHOU KIMREE TECHNOLOGY CO., LTD., Huizhou (CN)

(72) Inventors: Liyun Chen, Huizhou (CN); Dezhi Zhang, Huizhou (CN); Qiang Li, Huizhou (CN); Jun Zhang, Huizhou (CN)

(21) Appl. No.: 17/003,988

(22) Filed: Aug. 27, 2020

(30) Foreign Application Priority Data
Jun. 30, 2020 (CN) 202010625426.1

(51) Int. Cl. A24F 40/50; A24F 40/46; A24F 40/10; A24F 40/30

(52) U.S. Cl. CPC A24F 40/50; A24F 40/30; A24F 40/10; A24F 40/46

(57) ABSTRACT

The present application provides a disposable electronic cigarette with a large number of puffs and its control method. The electronic cigarette comprises a battery pack and atomizing assemblies arranged inside a housing, and the battery pack comprises an airflow switch assembly for sensing a suction signal and a control unit, there are least two groups of the atomizing assemblies, the control unit is used to receive the suction signal and control one of the atomizing assemblies to perform atomizing and heating smoke oil, and at the same time count number of puffs, and determine if the number of puffs reaches a default value, stop the heated atomizing assembly, and control to switch to another unheated atomizing assembly to perform atomizing and heating smoke oil. The disposable electronic cigarette can provide users with more number of puffs and longer time to smoke, and the taste is diversified.

### CROSS REFERENCE TO RELATED APPLICATIONS

The present application claims the benefit of Chinese Patent Application No. 202010625426.1 filed on Jun. 30, 2020, the contents of which are incorporated herein by reference in their entirety.

### FIELD OF THE PRESENT APPLICATION

The present application relates to a field of electronic cigarette, and more particularly relates to a disposable electronic cigarette with a large number of puffs and its control method.

### BACKGROUND OF THE PRESENT APPLICATION

At present, the popular disposable electronic cigarettes on the market have only one atomizing assembly. When most of them smoke about 200 puffs, the smoke oil will be consumed more, resulting in the smoke smell becoming very light or there is no smoke oil for users to continue smoking. However, the battery power is not exhausted at this time, resulting in poor user experience.

In addition, the existing disposable electronic cigarettes generally have a single taste. If users need to experience different tastes, they need to buy multiple electronic cigarettes. When users want to change other tastes after smoking for a period of time, they need to change the electronic cigarettes, which is inconvenient to use.

Therefore, it is necessary to provide a disposable electronic cigarette with a large number of puffs and its control method to solve the above technical problems.

### SUMMARY OF THE PRESENT APPLICATION

In view of the above technical problems in the related technologies, the present application provides a disposable electronic cigarette with a large number of puffs and its control method. Through the design of multiple groups of atomizing assemblies, each disposable electronic cigarette can provide users with more puffs and longer suction time, and the taste is diversified, which can meet more needs of customers.

To solve the above technical problem, the technical scheme of the application is as follows:

On the one hand, the present application provides a disposable electronic cigarette with a large number of puffs, comprising a battery pack and atomizing assemblies arranged inside a housing, and the battery pack comprises an airflow switch assembly for sensing a suction signal and a control unit electrically connected with the airflow switch assembly and the atomizing assemblies respectively, wherein, there are at least two groups of the atomizing assemblies, the control unit is used to receive the suction signal and control one of the atomizing assemblies to perform atomizing and heating smoke oil, and at the same time count number of puffs, and determine if the number of puffs reaches a default value, stop the heated atomizing assembly, and control to switch to another unheated atomizing assembly to perform atomizing and heating smoke oil.

Further, each of the atomizing assemblies comprises a heating element and an oil storage subassembly, and the smoke oils stored in the oil storage subassemblies in different atomizing assemblies store have the same or different tastes.

Further, the default value of the number of puffs is 200-400, the total number of puffs of the electronic cigarette is doubled with each additional atomizing assembly.

Further, at least two atomizing assemblies are coaxially arranged in one atomization channel; or at least two atomizing assemblies are arranged side by side in each independent atomization channel; and at least two atomizing assemblies are isolated from each other.

Further, the control unit comprises a control chip and a MOS transistor chip assembly which can be controlled and connected with the control chip, the control chip is used to receive a suction signal, generate a control signal and transmit it to the MOS transistor chip assembly to control each corresponding heating element for atomizing and heating.

Further, each of the atomizing assemblies comprises a first heating element and a second heating element, each of the atomizing assemblies further comprises a first air conduit arranged inside the housing, a first oil storage subassembly axially sheathed along an upper region of the first air conduit, a second oil storage subassembly axially sheathed along a lower region of the first air conduit, the first oil storage subassembly and the second oil storage subassembly are separated from each other by a first oil removal silica gel; the first heating element and the second heating element are axially arranged along the first air conduit and share one atomization channel.

Further, each of the atomizing assemblies comprises a first heating element and a second heating element, each of the atomizing assemblies further comprises a first air conduit arranged inside the housing, a first oil storage subassembly sleeved axially along the first air conduit, a second air conduit arranged in parallel with the first air conduit, a second oil storage subassembly sleeved axially along the second air conduit; the first heating element and the second heating element are arranged in parallel on the first air conduit and the second air conduit, and the inner of the first air conduit and the second air conduit are respectively provided with independent atomization channels.

Further, the battery pack further comprises a battery connected to the control unit and a control panel as a carrier of the control unit; the electronic cigarette further comprises a suction nozzle and a bottom cover respectively connected at the upper and lower ends of the housing, the bottom cover is butted with a head silicone seat of airflow switch, the airflow switch assembly is arranged on the head silicone seat of airflow switch and the airflow switch assembly is electrically connected with the control panel through an electronic wire.

On the other hand, the present application further provides a control method for an electronic cigarette, using the electronic cigarette according to any one of claims 1-8, wherein, the control method comprises: collecting the suction signal, and according to the collected suction signal, controlling one of the atomizing assemblies to perform atomizing and heating smoke oil, and at the same time counting number of puffs, and determining if the number of puffs reaches a first default value, stopping the heated atomizing assembly, and controlling to switch to another unheated atomizing assembly to perform atomizing and heating smoke oil.

Further, the control method further comprises performing timing while counting the number of puffs of a user, and determining if time of the timing reaches a second default value, stopping the heated atomizing assembly, and controlling to switch to another unheated atomizing assembly to perform atomizing and heating smoke oil.

Compared with the prior art, the present application has the following beneficial effects: through the design of the control unit and multiple groups of atomizing assembly, after the preset number of puffs or suction time of each group of atomizing assembly is reached, another group of atomizing assembly can be switched to continue to work, so that each disposable electronic cigarette can provide users with more puffs and longer suction time, and the taste is diversified, which can meet the needs of customers.

### BRIEF DESCRIPTION OF THE DRAWINGS

In order to more clearly explain the embodiment of the application or the technical scheme in the prior art, the following is a brief introduction to the drawings to be used in the embodiments. The drawings described below are only the corresponding drawings of some embodiments of the application.

FIG. 1 is the main sectional view of the disposable electronic cigarette with a large number of puffs according to the first embodiment of the present application.

FIG. 2 is the side sectional view of the disposable electronic cigarette with a large number of puffs according to the first embodiment of the present application.

FIG. 3 is the exploded view of the disposable electronic cigarette with a large number of puffs according to the first embodiment of the present application.

FIG. 4 is the main sectional view of the disposable electronic cigarette with a large number of puffs according to the second embodiment of the present application.

FIG. 5 is the side sectional view of the disposable electronic cigarette with a large number of puffs according to the second embodiment of the present application.

FIG. 6 is the exploded view of the disposable electronic cigarette with a large number of puffs according to the second embodiment of the present application.

FIG. 7 is a circuit diagram of a control chip according to an embodiment of the present application.

FIG. 8 is a circuit diagram of a dual channel PMOS transistor according to an embodiment of the present application.

In the Figures: housing 1, battery 2, head silicone seat of airflow switch 3, airflow switch assembly 4, control panel 5, suction nozzle 6, first heating element 7, second heating element 8, first air conduit 9, second air conduit 10, third air conduit 11, fourth air conduit 12, first oil storage subassembly 13, second oil storage subassembly 14, first oil removal silica gel 15, second oil removal silica gel 16, third oil removal silica gel 17, bottom cover 18, oil cup 19, fourth oil removal silica gel 20, fifth oil removal silica gel 21, first plastic pipe 22, second plastic pipe 23, first silicone plug 24, second silicone plug 25, oil absorbent cotton 26, atomization channel 27.

### DETAILED DESCRIPTION OF THE PREFERRED EMBODIMENT

In order to solve the problem of a small number of puffs and a single taste of disposable electronic cigarettes in the prior art, the present application aims to provide a disposable electronic cigarette with a large number of puffs. The core idea is: through the design of the control unit and multiple groups of atomizing assembly, after the preset number of puffs or suction time of each group of atomizing assembly is reached, another group of atomizing assembly can be switched to continue to work, so that each disposable electronic cigarette can provide users with more puffs and longer suction time, and the taste is diversified, which can meet the needs of customers.

It should be noted that when a component is referred to as “fixed to” or “arranged to” another part, it can be directly or indirectly located on that other part. When a part is called “connected” to another part, it can be directly or indirectly connected to the other part. The directions or positions indicated by the terms “up”, “down”, “left”, “right”, “front”, “back”, “vertical”, “horizontal”, “top”, “bottom”, “inside” and “outside” are based on the directions or positions shown in the attached drawings, which are only for the convenience of description and cannot be understood as a restriction on the technical solution. The terms “first”, “second” and so on are only used for the purpose of description, and cannot be understood as indicating or implying relative importance or implicitly indicating the quantity of technical features. “Multiple” means two or more, unless specifically defined otherwise.

In the following, the technical scheme in the embodiment of the application will be described clearly and completely in combination with the drawings in the embodiment of the application. Obviously, the described embodiment is only a part of the embodiment of the application, not all the embodiments. Based on the embodiment of the application, all other embodiments obtained by those skilled in the art without making creative labor fall within the scope of protection of the application.

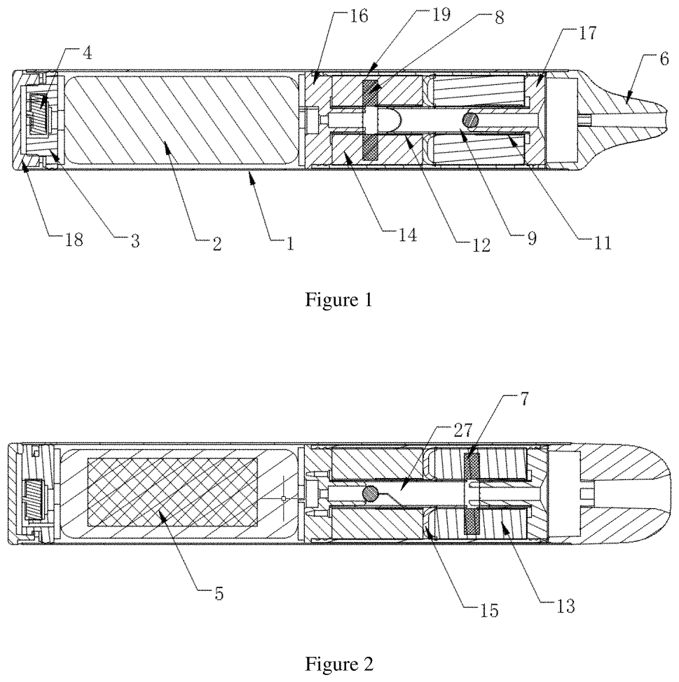

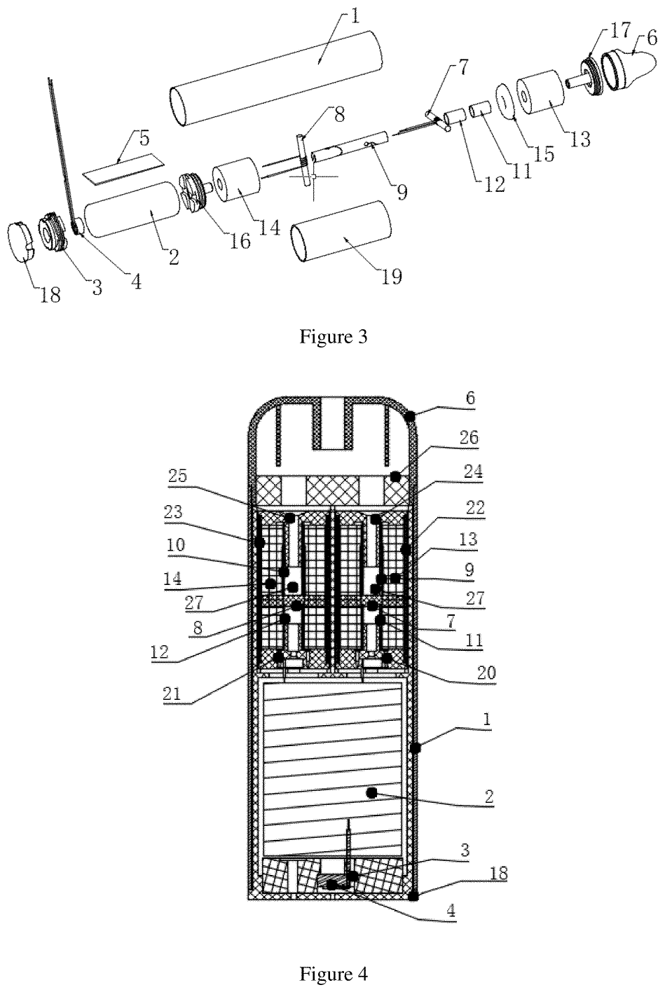

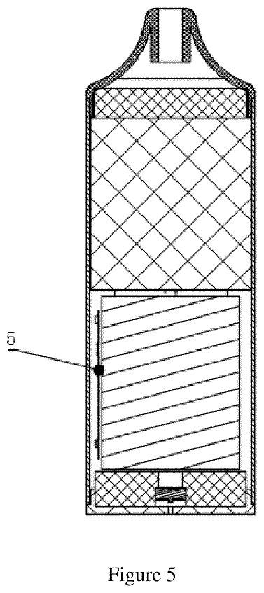

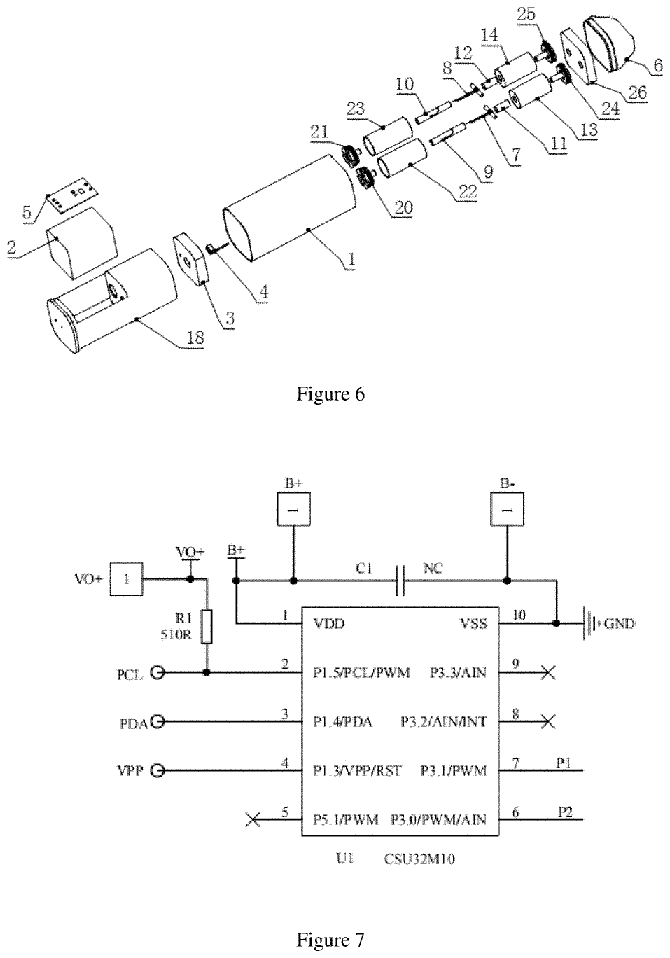

As shown in FIGS. 1-6, the disposable electronic cigarette with a large number of puffs according to the embodiments of the present application, comprises a battery pack and an atomizing assembly arranged inside a housing 1. The battery pack comprises an airflow switch assembly 4 (that is an airflow sensor) for sensing a suction signal and a control unit electrically connected with the airflow switch assembly 4 and the atomizing assembly respectively. There are least two groups of the atomizing assemblies the control unit is used to receive the suction signal and control one of the atomizing assemblies to perform atomizing and heating smoke oil, and at the same time count number of puffs, and determine if the number of puffs reaches a default value, stop the heated atomizing assembly, and control to switch to another unheated atomizing assembly to perform atomizing and heating smoke oil.

In a preferred embodiment of the present application, each of the atomizing assembly comprises a heating element and an oil storage subassembly, and the smoke oil stored in the oil storage subassemblies in different atomizing assemblies store has the same or different tastes.

In a preferred embodiment of the present application, the default value of the number of puffs is 200-400, the total number of puffs of the electronic cigarette is doubled with each additional atomizing assembly.

In a preferred embodiment of the present application, at least two atomizing assemblies are coaxially arranged in one atomization channel 27; or at least two atomizing assemblies are arranged side by side in each independent atomization channel 27, and at least two atomizing assemblies are isolated from each other.

In an embodiment of the present application, the control unit comprises a control chip and a MOS transistor chip assembly which can be controlled and connected with the control chip, the control chip is used to receive a suction signal, generate a control signal and transmit it to the MOS transistor chip assembly to control each corresponding heating element for atomizing and heating on.

Since the current products are all started up by the microphone, it is detected that the chip pin is always low level when it is not started, and it is always high level when smoking. The control component can count the specific number of puffs by counting the jumping times from low to high. Through the software presets a certain number of puffs, such as 250 (the corresponding atomizing assembly has less smoke oil and lighter smoke taste), when the count reaches the preset number, the control component controls the atomizing assembly to stop working and enable another group of atomizing assembly to work without affecting the user's taste experience.

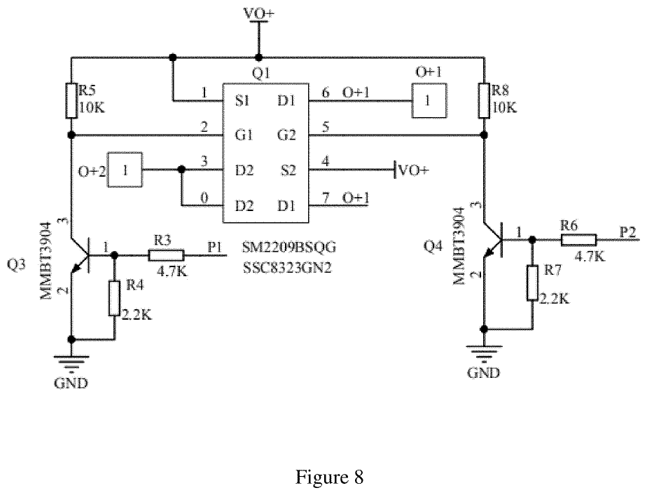

Specifically, as shown in FIG. 7 and FIG. 8, the control chip in FIG. 7 is an 8-bit MTP single-chip microcomputer, the model is U1 csu32m10, in which pin 1 is the power pin of the single-chip microcomputer; pin 2 is the input of external interrupt 1 and has wake-up function, the output level signal of airflow switch assembly 4 enters the MCU and it is also the programming clock line; pin 3 is the input of the external interrupt 1 and also the burn data line; pin 4 is the input of the external interrupt 1 for burning voltage; pin 5 is PWM output pin, pin 6 is PWM output pin, controlling drive signal of the base of the transistor Q4; pin 7 is the input of the external interrupt 1, PWM output pin, which controls the drive signal of the base of transistor Q3; Pin 8 is the input of the external interrupt 1, the ADC input channel; pin 9 is the input of the external interrupt 1, the external input of the timer/counter, ADC input channel; pin 10 is the ground pin of the microcontroller.

FIG. 8 shows the MOS transistor chip assembly of the control unit, including a dual channel PMOS chip (model: Q1 sm2209bsqg, ssc8323gn2), two control transistors. Two independent PMOS are integrated in the dual channel PMOS chip to control the operation of the heating module. Pin 1 is the source S1 of PMOS1, pin 2 is the gate G1 of PMOS1, pin 3 is the drain D2 of PMOS2, pin 4 is the source S2 of PMOS2, pin 5 is the gate G2 of PMOS2, pin 6 is the drain D1 of PMOS1, R5 and R8 are 10K pull-up resistance, the transistor Q3 controls G1, and the transistor Q4 controls G2. In the initial state, when the MCU detects the input of the output level signal of the airflow switch assembly 4, the driving signal P1 becomes high level, P2 is the default low level, P1 opens the base of transistor Q3, Q3 controls G1 and G1 changes to low level, thus making S1 to D1 of PMOS1 being turned on, and the heating component of channel 1 is turned on. At this time, the output voltage of PMOS1 is applied to heating element 1 (0+1) for heating, and the single-chip microcomputer synchronously detects the input of the microphone output level signal, and performs port count and timing. When the number of puffs of the first heating element reaches the set value, P1 becomes low level, PMOS1 is turned off, the heating element 1 (0+1) stops heating, and P2 controls the base of the transistor Q4, Q4 controls G2, and then turns on S2 to D2. The output voltage of PMOS2 is applied to heating element 2 (0+2) for heating, which realizes the heating switch of the heating element. When the number of puffs of the second heating element reaches the set value, the entire heating process is completed.

The above is the operating principle of the control unit of the present application. Next, the present application will be further explained through specific structural embodiments.

### The First Embodiment

As shown in FIGS. 1-3, in this preferred embodiment, the atomizing assembly comprises a first heating element 7 and a second heating element 8, and the atomizing assembly further comprises a first air conduit 9 arranged inside the housing 1, a first oil storage subassembly 13 axially sheathed along an upper region of the first air conduit 9, a second oil storage subassembly 14 axially sheathed along a lower region of the first air conduit 9, the first oil storage subassembly 13 and the second oil storage subassembly 14 are separated from each other by a first oil removal silica gel 15; wherein the first heating element 7 and the second heating element 8 are axially arranged along the first air conduit 9 and share one atomization channel 27.

Specially, in this preferred embodiment, the housing 1 is a cylindrical hollow tube of the battery 2, the bottom end of the tube of the battery 2 is provided with a bottom cover 18, the top of the tube of the battery 2 is provided with a suction nozzle 6, the bottom cover 18 and the suction nozzle 6 are provided with through holes for air supply flow. The hollow interior of the tube of the battery 2 is divided into upper and lower spaces, the upper space is used to set the atomizing assembly, and the lower space is used to set the battery module.

The battery pack of the present embodiment includes not only an airflow switch assembly 4 for sensing the suction signal and a control unit electrically connected with the airflow switch assembly 4 and the atomizing assembly respectively, but also a battery 2 connected with the control unit and a control panel 5 as the carrier of the control unit. In this embodiment, the airflow switch assembly 4 is arranged on the head silicone seat of airflow switch 3, and the head silicone seat of airflow switch 3 is butted on the bottom cover 18. In addition, in this embodiment, the battery 2 is cylindrical and is arranged above the head silicone seat of airflow switch 3 (right side in the figure). The control panel 5 is the FPC control panel 5, which is arranged on the surface of the battery 2 and is electrically connected with the battery 2. The airflow switch assembly 4 is electrically connected with the FPC control panel 5 through an electronic wire. In addition, a through hole is arranged on the head silicone seat of airflow switch 3, the airflow switch assembly 4 is arranged on the air flow channel where the through hole is located. There is also a gap between the battery 2 and the inner wall of the tube of the battery 2 for air supply flow.

The atomizing assembly of the embodiment is also provided with a cylindrical oil cup 19 with hollow upper and lower parts. The outer wall of the oil cup 19 is connected with the inner wall of the tube of the battery 2. The bottom end of the oil cup 19 (left side in the figure) is isolated from the battery pack by the second oil removal silica gel 16. The center of the second oil removal silica gel 16 is provided with a through-hole, and its upper side (right side in the picture) is provided with a hollow tube connected with the through-hole, and its lower side is provided with an irregular bulge, which makes a certain gap between it and the battery pack, so that the air flow can pass through. In addition, the oil storage subassembly in this embodiment is a cylindrical oil storage cotton with a through hole in the middle (in other embodiments, it can also be an oil storage chamber and other components), and includes a first oil storage subassembly 13 and a second oil storage subassembly 14. In this embodiment, one end of the second oil storage subassembly 14 is just sheathed on the hollow tube of the second oil removal silica gel 16, the other end of the second oil storage subassembly 14 is arranged in the lower area of the first air conduit 9, and the through hole of the second oil storage subassembly 14 is also provided with a fourth air conduit 12, one end of the fourth air conduit 12 is sheathed on the first air conduit 9, and the other end is sheathed on the hollow tube of the second oil removal silica gel 16 to form an air flow channel isolated from the second oil storage subassembly 14.

Similarly, the top of the oil cup 19 (on the right side in the picture) is isolated from the suction nozzle 6 through the third oil removal silica gel 17. The center of the third oil removal silica gel 17 is provided with a through hole, and its lower side (left side in the figure) is provided with a hollow pipe connected with the through-hole, and its upper side is connected with the air flow channel of the suction nozzle 6. In this embodiment, one end of the first oil storage subassembly 13 is just sheathed on the hollow tube of the third oil removal silica gel 17, the other end of the first oil storage subassembly 13 is sheathed in the upper area of the first air conduit 9, and a third air conduit 11 is also arranged in the through hole of the first oil storage subassembly 13. One end of the third air conduit 11 is sheathed on the first air conduit 9, and the other end is sheathed on the hollow tube of the third oil removal silica gel 17 to form an air flow channel isolated from the first oil storage subassembly 13.

In addition, the first oil storage subassembly 13 and the second oil storage subassembly 14 are separated by the first oil removal silica gel 15, so that smoke oil with different tastes will not be mixed. The first heating element 7 and the second heating element 8 are arranged at the incision on the first air conduit 9, and the transverse (vertical) parts of the two components are perpendicular to each other, and are inserted into the oil storage subassembly to contact with the oil storage subassembly, so as to facilitate heating and atomizing smoke oil. A connecting wire is also arranged in the vertical direction (transverse in the figure) of them, which is electrically connected with the control panel 5 below through the air flow channel.

Through the above embodiment, two groups of atomizing assemblies are coaxial arranged in one atomization channel 27, and the atomization channel 27 is connected with the air flow channel. In addition, the design of the control unit enables the control unit to control the work of the two groups of atomizing assembly, so as to achieve the purpose of switching each group of atomizing assembly to another group of atomizing assembly after reaching the preset number of puffs or suction time, so that each disposable electronic cigarette can provide users with more puffs and longer time to smoke, and the taste is diversified and no longer single, which can meet more needs of customers.

### The Second Embodiment

As shown in FIGS. 4-6, in this preferred embodiment, the atomizing assembly comprises a first heating element 7 and a second heating element 8. The atomizing assembly further comprises a first air conduit 9 arranged inside the housing 1, a first oil storage subassembly 13 sleeved axially along the first air conduit 9, a second air conduit 10 arranged in parallel with the first air conduit 9, a second oil storage subassembly 14 sleeved axially along the second air conduit 10; the first heating element 7 and the second heating element 8 are arranged in parallel on the first air conduit 9 and the second air conduit 10, and the inner of the first air conduit 9 and the second air conduit 10 are respectively provided with independent atomization channel 27.

Specifically, in this preferred embodiment, the housing 1 is a square hollow aluminum tube, the bottom end of the aluminum tube is provided with a bottom cover 18, the top of the aluminum tube is provided with a suction nozzle 6, both the bottom cover 18 and the suction nozzle 6 are provided with through holes for air supply flow, the hollow interior of the tube of the battery 2 is divided into two spaces, the upper space is used to set the atomizing assembly, and the lower space is used to set the battery pack.

The battery pack of the present embodiment includes not only an airflow switch assembly 4 for sensing the suction signal and a control unit electrically connected with the airflow switch assembly 4 and the atomizing assembly respectively, but also a battery 2 connected with the control unit and a control panel 5 as the carrier of the control unit. In the present embodiment, the bottom cover 18 is also provided with a bracket for opening an installation groove, and the bracket is also provided with an air flow through hole. The airflow switch assembly 4 is arranged on the head silicone seat of airflow switch 3, and the head silicone seat of airflow switch 3 is butted on the bottom cover 18. In addition, in this embodiment, the battery 2 is square and is arranged in the installation slot above the head silicone seat of airflow switch 3. The control panel 5 is a PCB board, which is pasted on the surface of the battery 2 and is electrically connected with the battery 2. The airflow switch assembly 4 is electrically connected with the PCB board through an electronic wire. In addition, a through-hole connected with the through-hole of the bottom cover 18 is arranged on the head silicone seat of airflow switch 3, the airflow switch assembly 4 is arranged on the air flow channel where the through hole is located, and there are also gaps between the battery 2, the inner wall of the aluminum tube and the through-hole of the bracket, so as to pass through the air supply flow.

The atomizing assembly of the embodiment is also provided with two cylindrical plastic pipes with hollow upper and lower parts. The two plastic pipes are respectively the first plastic pipe 22 and the second plastic pipe 23, which are arranged in the aluminum tube side by side. Among them, the bottom of the first plastic pipe 22 is oil isolated from the bracket of the battery pack through the fourth oil removal silica gel 20; the bottom of the second plastic pipe 23 is oil isolated from the bracket of the battery pack through the fifth oil removal silica gel 21; the centers of the fourth oil removal silica gel 20 and the fifth oil removal silica gel 21 are both provided with through holes; the upper sides of both are provided with hollow pipes connected with the through holes; the lower sides of the two are provided with irregular bulges. There is a certain gap between the irregular protrusion and the bracket to facilitate the air flow. In addition, the through-hole in the center of the fourth oil removal silica gel 20 and the fifth oil removal silica gel 21 is preferably corresponding to the through-hole position on the bracket, which is more conducive to the flow of air.

The oil storage subassembly in this embodiment is a cylindrical oil storage cotton with a through-hole in the middle (in other embodiments, it can also be an oil storage chamber and other components), and includes a first oil storage subassembly 13 and a second oil storage subassembly 14.

The first oil storage subassembly 13 described in the embodiment is attached to the first plastic pipe 22, the first heating wire assembly is mounted on the first air conduit 9, the first air conduit 9 is located in the through hole of the first oil storage subassembly 13, and the upper end of the first air conduit 9 is provided with a first silicone plug 24 with a through hole. The plug head part of the first silicone plug 24 is located above the first oil storage subassembly 13. The through hole of the first oil storage subassembly 13 is also provided with a third air conduit 11. One end of the third air conduit 11 is sheathed on the first air conduit 9, and the other end is sheathed on the hollow tube of the fourth oil removal silica gel 20 to form an air flow channel isolated from the first oil storage subassembly 13. The first heating wire assembly includes a transverse part and a vertical part, and the transverse part is inserted into the first oil storage subassembly 13 to contact with the oil storage subassembly, so as to facilitate heating and atomizing the smoke oil. The vertical part is provided with a connecting wire which is electrically connected with control panel 5 in the lower space through the air flow channel.

Similarly, the second oil storage subassembly 14 in this embodiment is attached to the second plastic pipe 23, the second heating wire assembly is mounted on the second air conduit 10, and the second air conduit 10 is located in the through hole of the second oil storage subassembly 14. The upper end of the second air conduit 10 is provided with a second silicone plug 25 with a through hole, and the plug head part of the second silicone plug 25 is located above the second oil storage subassembly 14. The through-hole of the second oil storage subassembly 14 is also provided with a fourth air conduit 12, one end of the fourth air conduit 12 is sheathed on the second air conduit 10, and the other end is sheathed on the hollow tube of the fifth oil removal silica gel 21 to form an air flow channel isolated from the second oil storage assembly 14. The second heating wire assembly includes a transverse part and a vertical part, the transverse part is inserted into the second oil storage subassembly 14 to contact with the oil storage component, so as to facilitate heating and atomizing the smoke oil, while the vertical part is provided with a connecting wire which is electrically connected with control panel 5 in the lower space through the air flow channel.

In addition, an oil absorbent cotton 26 is arranged above the first silicone plug 24 and the second silicone plug 25, which is tightly fixed in the suction nozzle 6, and the oil absorbent cotton 26 is provided with a through-hole corresponding to the through-hole positions of the first silicone plug 24 and the second silicone plug 25 to ensure the smooth air flow channel.

According to the above embodiment, two groups of atomizing assemblies are arranged in parallel in two separate atomization channels 27, and the two atomization channels 27 are respectively communicated with the air flow channels. In addition, the design of the control unit enables the control unit to control the work of the two groups of atomizing assembly, so as to achieve the purpose of switching each group of atomizing assembly to another group of atomizing assembly after reaching the preset number of puffs or suction time, so that each disposable electronic cigarette can provide users with more puffs and longer time to smoke, and the taste is diversified and no longer single, which can meet more needs of customers.

### The Third Embodiment

The embodiment provides a control method for an electronic cigarette, comprising: collecting the suction signal, and according to the collected suction signal, controlling one of the atomizing assemblies to perform atomizing and heating smoke oil, and at the same time counting number of puffs, and determining if the number of puffs reaches a first default value, stopping the heated atomizing assembly, and controlling to switch to another unheated atomizing assembly to perform atomizing and heating smoke oil

The embodiment further comprises performing timing while counting the number of puffs of a user, and determining if time of the timing reaches a second default value, stopping the heated atomizing assembly, and controlling to switch to another unheated atomizing assembly to perform atomizing and heating smoke oil.

That is to say, when the number of puffs reaches the first default value or the timing time reaches the second default value, the heated atomizing assembly is controlled to stop and switch to another unheated atomizing assembly for the atomization and heating of smoke oil.

To sum up, in the present application, through the design of the control unit and multiple groups of atomizing assembly, after the preset number of puffs or suction time of each group of atomizing assembly is reached, another group of atomizing assembly can be switched to continue to work, so that each disposable electronic cigarette can provide users with more puffs and longer suction time, and the taste is diversified, which can meet the needs of customers.

To sum up, although the present application has been disclosed by preferred embodiments, the above preferred embodiments are not intended to limit the application. Ordinary technical personnel in the art can make various modifications and refinements without departing from the spirit and scope of the application. Therefore, the scope of protection of the application is subject to the scope defined in the claims.

1. A disposable electronic cigarette with a large number of puffs, comprising a battery pack and atomizing assemblies arranged inside a housing, and the battery pack comprises an airflow switch assembly for sensing a suction signal and a control unit electrically connected with the airflow switch assembly and the atomizing assemblies respectively, wherein, there are least two groups of the atomizing assemblies, the control unit is used to receive the suction signal and control one of the atomizing assemblies to perform atomizing and heating smoke oil, and at the same time count number of puffs, and determine if the number of puffs reaches a default value, stop the heated atomizing assembly, and control to switch to another unheated atomizing assembly to perform atomizing and heating smoke oil.

2. The electronic cigarette according to claim 1, wherein, each of the atomizing assemblies comprises a heating element and an oil storage subassembly, and the smoke oils stored in the oil storage subassemblies in different atomizing assemblies have the same or different tastes.

3. The electronic cigarette according to claim 1, wherein, the default value of the number of puffs is 200-400, the total number of puffs of the electronic cigarette is doubled with each additional atomizing assembly.

4. The electronic cigarette according to claim 1, wherein, at least two atomizing assemblies are coaxially arranged in one atomization channel;
or at least two atomizing assemblies are arranged side by side in each independent atomization channel;
and at least two atomizing assemblies are isolated from each other.

5. The electronic cigarette according to claim 1, wherein, the control unit comprises a control chip and a MOS transistor chip assembly which can be controlled and connected with the control chip, the control chip is used to receive a suction signal, generate a control signal and transmit it to the MOS transistor chip assembly to control each corresponding heating element for atomizing and heating.

6. The electronic cigarette according to claim 2, wherein, each of the atomizing assemblies, comprises a first heating element and a second heating element, each of the atomizing assemblies, further comprises a first air conduit arranged inside the housing, a first oil storage subassembly axially sheathed along an upper region of the first air conduit, a second oil storage subassembly axially sheathed along a lower region of the first air conduit, the first oil storage subassembly and the second oil storage subassembly are separated from each other by a first oil removal silica gel;
the first heating element and the second heating element are axially arranged along the first air conduit and share one atomization channel.

7. The electronic cigarette according to claim 2, wherein, each of the atomizing assemblies comprises a first heating element and a second heating element, each of the atomizing assemblies further comprises a first air conduit arranged inside the housing, a first oil storage subassembly sleeved axially along the first air conduit, a second air conduit arranged in parallel with the first air conduit, a second oil storage subassembly sleeved axially along the second air conduit;
the first heating element and the second heating element are arranged in parallel on the first air conduit and the second air conduit, and the inner of the first air conduit and the second air conduit are respectively provided with independent atomization channels.

8. The electronic cigarette according to claim 2, wherein, the battery pack further comprises a battery connected to the control unit and a control panel as a carrier of the control unit;
the electronic cigarette further comprises a suction nozzle and a bottom cover respectively connected at the upper and lower ends of the housing, the bottom cover is butted with a head silicone seat of airflow switch, the airflow switch assembly is arranged on the head silicone seat of airflow switch and the airflow switch assembly is electrically connected with the control panel through an electronic wire.

9. A control method for an electronic cigarette, using the electronic cigarette according to claim 1, wherein, the control method comprises: collecting the suction signal, and according to the collected suction signal, controlling one of the atomizing assemblies to perform atomizing and heating smoke oil, and at the same time counting number of puffs, and determining if the number of puffs reaches a first default value, stopping the heated atomizing assembly, and controlling to switch to another unheated atomizing assembly to perform atomizing and heating smoke oil.

10. The control method for an electronic cigarette according to claim 9, wherein, further comprises performing timing while counting the number of puffs of an user, and determining if time of the timing reaches a second default value, stopping the heated atomizing assembly, and controlling to switch to another unheated atomizing assembly to perform atomizing and heating smoke oil.
